(19) United States
(12) Patent Application Publication
(10) Pub. No.: US 2006/0218565 A1
(43) Pub. Date: Sep. 28, 2006

(54) Structure of attaching disk loader

(75) Inventor: Kazuki Kajikawa, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/374,988

(22) Filed: Mar. 15, 2006

(30) Foreign Application Priority Data
Mar. 25, 2005 (JP) P2005-087744

(51) Int. Cl. G11B 33/02; G11B 17/04

(52) U.S. Cl. 720/613; 720/601

(57) ABSTRACT

A structure of attaching a disk loader includes: an outer housing being divided into a top case, a bottom case including a bottom plate, and a front panel; and a substantially rectangular frame comprising a disk loading element including a disk tray. The outer housing comprises a first holding unit, a second holding unit. The rectangular frame can be configured to be fixed by a plurality of screws onto the bottom plate. Instead of fixing the rectangular frame to the bottom plate of the bottom case by the plurality of screws, the frame is held in a lateral direction and a vertical direction by the first holding unit and is held in a longitudinal direction by a second holding unit. The first holding unit has a function of allowing the rectangular frame to slide in the longitudinal direction.

### CROSS-REFERENCE TO RELATED APPLICATIONS

This application is based on and claims the benefit of priority from the prior Japanese Patent Application No. 2005-87744, filed on Mar. 25, 2005; the entire contents of which are incorporated herein by reference.

### TECHNICAL FIELD

The present invention relates to a structure of attaching a disk loader, and more particularly relates to a structure of attaching a disk loader employed when a disk loader used for DVD player is attached to an outer housing.

### BACKGROUND

As exemplarily shown in FIG. 5 which is a perspective view showing an outline of the disk loader A, the disk loader A used for DVD player includes: a frame 1 which functions as a chassis; a disk tray 2 which proceeds and retracts in the longitudinal direction so as to convey a disk (not shown); a clamper 3 for clamping and rotating the disk; and elements (disk loading elements), for processing the disk, such as an optical pickup (not shown) which conducts scanning on a recording face of the rotating disk.

In order to accommodate this type disk loader in an outer housing so that it can be made to be a stationary type disk loader, the disk loader must be fixed to the outer housing. In general, the outer housing is formed into a box-shape composed of a bottom case, a top case and a front panel. It is conventional that the disk loader is fixed to a bottom plate of the bottom case by screws and then the top case is attached to the bottom case and the front panel is attached to the bottom case. In order to conduct screwing as described above, the following method is employed. As shown in FIG. 5, two attaching pieces 11, 12 are respectively arranged on both sides of the frame 1. In the case of fixing the disk loader to the bottom case by screwing, four screws inserted into these attaching pieces 11, 12 are screwed and fastened into the screw holes formed on the bottom plate of the bottom case.

On the other hand, in the same manner as that explained in FIG. 5, a disk loader is known in which a stand used for screwing is provided in the periphery. This disk loader is disclosed, for example, in JP-A-2002-100094 (FIG. 43). The fundamental structure of the disk loader is known, and various investigations have been made into the mechanism of sliding the disk tray in the longitudinal direction. Concerning this technique, refer to JP-A-8-221864, JP-A-7-153163, and JP-A-63-244442.

### SUMMARY

According to the structure of attaching a disk loader, the following problems may be encountered. When the disk loader is fixed to the bottom case of the outer casing with screws, attaching screws are redundantly required. It is troublesome and complicated to insert and fasten the attaching screws into the screw holes. Accordingly, the number of parts is increased and further the number of man-hours is increased, which results in an increase in the manufacturing cost. These problems can not be solved by applying the technique proposed by JP-A-2002-100094 which only shows a disk loader fastened with screws and by applying the technique proposed by P JP-A-8-221864, JP-A-7-153163, and JP-A-63-2444424 which only show a disk loader of the well known structure having a sliding mechanism of a disk tray.

The present invention has been accomplished to solve the above problems and provides a structure of attaching a disk loader capable of fixing the disk loader at a predetermined position in an outer housing without using redundant parts such as attaching screws and without conducting a troublesome work such as fastening attaching screws instead of attaching the disk loader with screws.

According to an aspect of the invention, there is provided a structure of attaching a disk loader, including: an outer housing being divided into a top case, a bottom case including a bottom plate, and a front panel, the outer housing comprising a first holding unit, a second holding unit; and a substantially rectangular frame comprising a disk loading element including a disk tray, the rectangular frame capable of being configured to be fixed by a plurality of screws onto the bottom plate. Instead of fixing the rectangular frame to the bottom plate of the bottom case by the plurality of screws, the frame is held in a lateral direction and a vertical direction by the first holding unit and is held in a longitudinal direction by a second holding unit. The first holding unit has a function of allowing the rectangular frame to slide in the longitudinal direction.

By the above-structure, the disk loader can be positioned and fixed at a position in three directions, which are perpendicular to each other, by the first holding unit and the second holding unit. Therefore, it becomes unnecessary to use redundant screws, and a screwing work to fasten the attaching screws is not needed. Accordingly, the attaching work property can be improved and the mass production property can be also improved.

### BRIEF DESCRIPTION OF THE DRAWINGS

These and other objects and advantages of this invention will become more fully apparent from the following detailed description taken with the accompanying drawings in which:

FIG. 1 is a plan view showing an outline of the attaching structure of the disk loader of the embodiment of the present invention, wherein a portion of the attaching structure is omitted in the drawing;

FIG. 2 is a front view showing an outline of the primary portion of the attaching structure;

FIG. 3 is a side view of the primary portion of the attaching structure;

FIG. 4 is a schematic illustration showing a procedure of attaching the disk loader;

FIG. 5 is a perspective view showing an outline of the fundamental structure of the disk loader.

### DESCRIPTION OF THE EMBODIMENTS

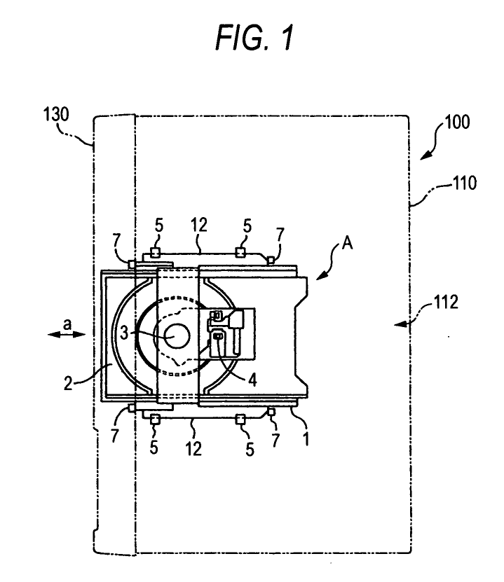

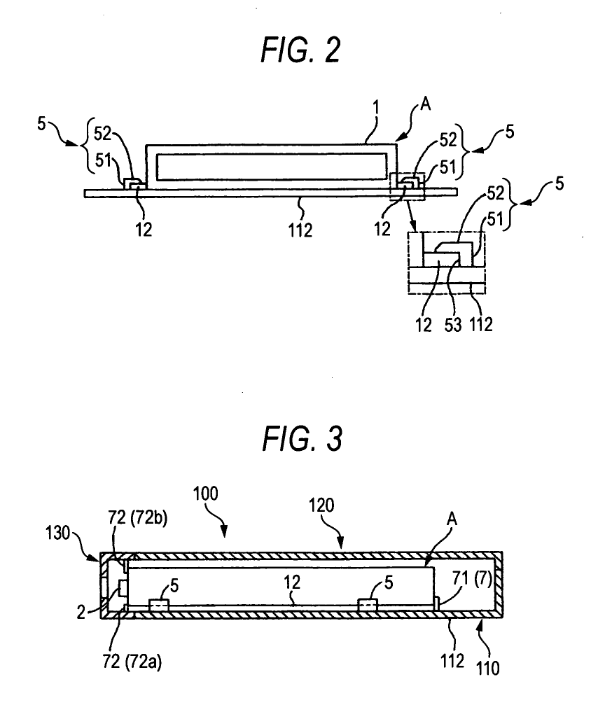

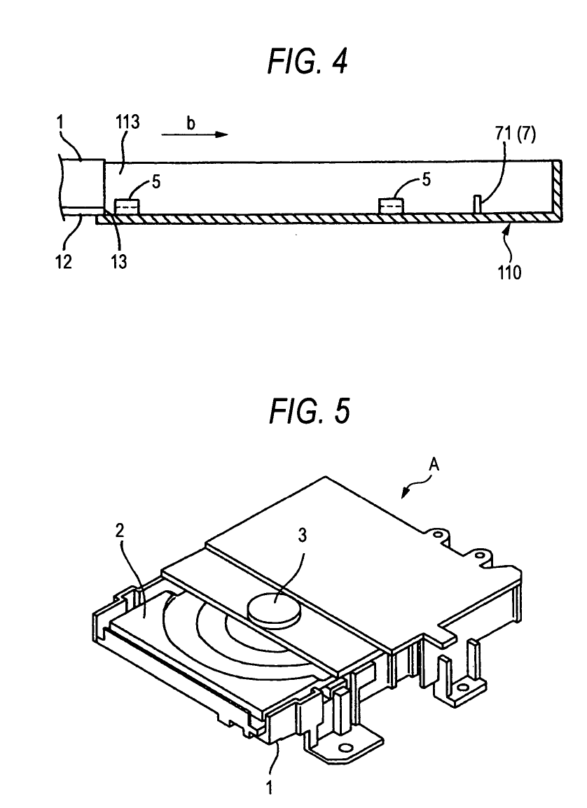

FIG. 1 is a plan view showing an outline of the attaching structure of the disk loader of an embodiment, wherein a portion of the attaching structure is omitted in the drawing, FIG. 2 is a front view showing an outline of the primary portion of the attaching structure, FIG. 3 is a side view of the primary portion of the attaching structure, and FIG. 4 is a schematic illustration showing a procedure of attaching the disk loader.

The disk loader A shown in FIG. 1 includes: a substantially rectangular frame 1; a disk tray 2 proceeding and retracting in the longitudinal direction (the direction of arrow “a”) for conveying a disk (not shown); a clamper 3 for clamping and rotating the disk; and an optical pickup 4, which is an element (disk loading element) for processing the disk, for conducting scanning on the rotating disk. On both sides of the frame 1 in the lateral direction, the attaching pieces 12, 12 extending in the longitudinal direction are integrally formed out of resin. This disk loader A is attached to the outer housing 100 by the first holding unit 5 and the second holding unit 7 described later via the attaching pieces 12, 12 without using redundant parts such as screws. As explanatorily shown in FIG. 3, the outer housing 100 is composed of a bottom case 110, a top case 120 and a front panel 130 which are assembled to each other so that they can be formed into a flat box-shape. The front face and the upper face of the bottom case 110 are open and the front face and the lower face of the top case 120 are open.

As explanatorily shown in FIG. 2, the first holding unit 5 is provided on the bottom plate 112 of the bottom case 110. This first holding unit 5 includes: a pair of rising pieces 51, 51 for pinching the disk loader A, which is put on the bottom plate 112, from both sides in the lateral direction; and pushing pieces 52, 52, which are directed in the lateral direction, individually arranged for the rising pieces 51, 51. With the groove-shaped portion 53 composed of the rising piece 51, the pushing piece 52 and the bottom plate 112 of the bottom case 110, the above attaching piece 12 provided in the frame 1 of the disk loader A is engaged. The first holding unit 5 composed as described above is arranged being divided into two portions in the longitudinal direction at the central portion in the lateral direction of the bottom plate 112 of the bottom case 110. The right 51 and the left rising piece 51 of the first holding unit 5, 5, which are arranged in the longitudinal direction, come into contact with the outer end faces of the attaching pieces 12, 12 so that the disk loader A can be positioned in the lateral direction. Further, the right holding piece 52 and the left holding piece 52 of the first holding unit 5, 5 and the bottom plate 112 of the bottom case 110 cooperate with each other and pinch the right holding piece 12 and the left holding piece 12 so that the disk loader A can be positioned in the vertical direction. As described above, the first holding unit 5 only conducts positioning on the disk loader A in the two directions of the lateral direction and the vertical direction which are perpendicular to each other. Therefore, the first holding unit 5 has a function of allowing the disk loader A to slide in the longitudinal direction.

As explanatorily shown in FIG. 3, the second holding unit 7 includes a pair of engaging pieces 71, 72 arranged in the longitudinal direction on the bottom plate 112 of the bottom case 110 and the front case 130. In the example shown in the drawing, the engaging piece 72 on the front case 130 side is divided into the protruding piece 72a on the lower side and the hanging piece 72b on the upper side. A pair of engaging pieces 71, 72 arranged in the longitudinal direction pinch the frame 1 of the disk loader A in the longitudinal direction, so that the disk loader A can be positioned in the longitudinal direction. Accordingly, by the positioning function of this second holding unit 7, the sliding function of the disk loader A, which is allowed by the first holding unit 5 as described before, is restricted. Accordingly, the disk loader A can be positioned and fixed in the three directions of the lateral direction, the vertical direction and the longitudinal direction, which are perpendicular to each other, by the first holding unit 5 and the second holding unit 7. In this embodiment, as shown in FIG. 1, the second holding unit 7 is arranged being divided into two portions in the lateral direction in the central portion in the lateral direction of the bottom plate 112 of the bottom case 110. Due to the above structure, the right and the left side portion of the disk loader A can be held in the longitudinal direction. Therefore, the disk loader A can be positively positioned in the longitudinal direction.

In this embodiment, the first holding unit 5 holds two portions of the disk loader A in the longitudinal direction. However, concerning this point, the disk loader A may be held in one portion in the longitudinal direction. Alternatively, the disk loader A may be held in portions, the number of which is not less than two. Further, it is possible to adopt such a structure that the longitudinal widths of the rising piece 51 and the pushing piece 52 of the first holding unit 5 are extended and the rising piece 51 and the pushing piece 52 pinch and press the substantially entire length portion of the attaching piece 12 of the frame 1. In the same manner, in the second holding unit 7, the disk loader A may be held in on portion in the lateral direction. Alternatively, the disk loader A may be held in portions in the lateral direction, the number of which is not less than two.

Referring to the attaching structure explanatorily shown in FIG. 4, the procedure of attaching the disk loader A will be explained below.

Before the top case 120 and the front case 130 (shown in FIG. 3) are attached, the rear end portion of the disk loader 1 is made to face the opening 112 on the front face of the bottom case 110 as shown in FIG. 4. Then, the right and the left attaching piece 12 in the lateral direction of the frame 1 of the disk loader 1 are engaged with the groove-shaped portion 53 explained in FIG. 2. After that, the disk loader A is pushed backward as shown by the arrow “b”, and the rear end portion 13 of the disk loader A is made to collide with the engaging piece 71 provided on the bottom case 110 side. In this way, the disk loader A is received by the engaging piece 71. After that, the top case 120 and the front case 130 are put together with the bottom case 110 so as to assemble the outer housing 100. In this way, the disk loader A can be attached at a predetermined position in the outer housing 100 by the positioning action conducted by the first holding unit 5 and the second holding unit 7.

In this embodiment, the bottom case 110 can be made of sheet metal or resin. In the case where the bottom case 110 is made of sheet metal, the rising piece 51 and the pushing piece 52 of the first holding unit 5 can be formed integrally with the bottom plate 112 of the bottom case 110 by raising a portion of the bottom plate 112. In the case where the bottom case 110 is made of resin, the rising piece 51 and the pushing piece 52 can be formed integrally with the bottom case 110 when the bottom case 110 is formed by molding. The circumstances are the same as those of the engaging piece 71 on the bottom case 110 side of the second holding unit 7 and the engaging piece 72 on the front panel 130 side. Therefore, it is possible to provide a structure of attaching the disk loader A, the attaching property of which is excellent, without increasing the number of parts. Accordingly, the mass production property of DVD player can be improved.

Although the front side engaging piece 72 of the second holding unit 7 is provided on the front panel 130, it can be provided on the top case 120. A soft elastic member such as a sheet of rubber or cloth may be stuck onto the engaging piece 71 on the bottom case 110 side. According to this structure, the disk loader A is elastically held by the second holding unit 7. Therefore, the occurrence of rattling can be prevented.

According to the above-embodiments, the first holding unit includes a pair of rising pieces integrally provided on the bottom plate of the bottom case, for pinching the frame from both sides and also includes pushing pieces respectively provided with respect to the rising pieces, for pinching the frame between the pushing pieces and the bottom plate. It is also preferable that the pushing pieces are respectively individually provided for the pair of rising pieces. When this structure is employed, in the case where the bottom case is made of sheet metal, the rising pieces and the pushing pieces can be formed by raising a portion of the bottom plate of the bottom case. In the case where the bottom case is composed of a resin molding, it is possible to provide an advantage that the rising pieces and the pushing pieces can be integrally formed together with the formation of the bottom case. Therefore, the first holding unit does not need such parts as screws. Accordingly, the manufacturing cost can be easily reduced. At the same time, the attaching property can be improved and the mass production property can be also improved.

According to the above-embodiments, the second holding unit includes a pair of engaging pieces respectively provided on the bottom plate of the bottom case and the top case or on the bottom plate and the front panel, for pinching the frame in the longitudinal direction. Due to the foregoing, when the top case and the front panel are attached to the bottom case to which the disk loader is positioned and fixed in the longitudinal direction and the vertical direction by the first holding unit described before, the disk loader can be also positioned and fixed in the longitudinal direction. Accordingly, it becomes unnecessary for the first holding unit and the second holding unit to use such parts as attaching screws. Accordingly, the manufacturing cost can be easily reduced. At the same time, the attaching property can be improved and the mass production property can be also improved.

According to the above-embodiments, the attaching piece extending in the longitudinal direction provided in the frame is slidably engaged with the groove-shaped portion, which is formed by the rising pieces of the first holding unit, the pushing pieces provided in the rising pieces and the bottom plate of the bottom case, so that the attaching piece can slide in the longitudinal direction. Due to the foregoing, in the case of attaching the disk loader to the bottom case, only when the frame of the disk loader is engaged with and pushed into the groove-shaped portion, the disk loader can be positioned to the bottom case. Therefore, the attaching work can be easily and positively executed, and the mass production property can be remarkably improved as compared with a case in which the attaching work is conducted with the attaching screws.

According to the above-embodiments, a structure of attaching a disk loader in which a substantially rectangular frame of the disk loader having disk loading elements such as a disk tray and others is fixed by a plurality of screws onto a bottom plate of a bottom case of an outer housing which is divided into the bottom case, a top case and a front panel, and front faces of the bottom case and the top case are open, characterized in that: instead of fixing the frame to the bottom plate of the bottom case by screws, the frame is held in the lateral direction and the vertical direction by a first holding unit provided in the outer housing; and the frame is held in the longitudinal direction by a second holding unit provided in the outer housing. The first holding unit includes: a pair of rising pieces provided on a bottom plate of the bottom case, for pinching the frame from both sides; and pushing pieces provided on the bottom plate of the bottom case, for pinching the frame between the pushing pieces and the bottom plate. An attaching piece provided in the frame extending in the longitudinal direction is slidably engaged with a groove-shaped portion formed by the rising piece of the first holding unit, the pushing piece provided for the rising piece and the bottom plate of the bottom case so that the attaching piece can be freely slid in the longitudinal direction. The second holding unit includes a pair of engaging pieces individually provided on the bottom plate of the bottom case and the top case or on the bottom plate of the bottom case and the front panel so as to pinch the frame in the longitudinal direction. When the attaching piece is engaged with the groove-shaped portion and the disk loader is slid and pushed backward, the engaging piece on the bottom plate side receives the rear end of the frame and conducts positioning on the disk loader. When the above constitution is adopted, the present invention can be more specifically realized. The action of the present invention will be explained in detail referring to the embodiment described later.

According to the above-embodiments, instead of attaching the disk loader with screws, without using redundant parts such as attaching screws which require a troublesome work of fastening the attaching screws, the disk loader can be fixed at a predetermined position in the outer housing. Therefore, it becomes unnecessary to use redundant parts such as screws. Further, a troublesome work such as a fastening work of the attaching screws can be avoided. Therefore, the attaching property can be greatly improved and the manufacturing cost can be reduced. Accordingly, the mass production property in the assembling line of the factory can be improved. Further, DVD players, in which the disk loader is accommodated in the outer housing, can be provided at an inexpensive price.

What is claimed is:

1. A structure of attaching a disk loader, comprising:
an outer housing being divided into a top case, a bottom case including a bottom plate, and a front panel, the outer housing comprising a first holding unit, a second holding unit; and
a substantially rectangular frame comprising a disk loading element including a disk tray, the rectangular frame capable of being configured to be fixed by a plurality of screws onto the bottom plate, wherein, instead of fixing the rectangular frame to the bottom plate of the bottom case by the plurality of screws, the frame is held in a lateral direction and a vertical direction by the first holding unit and is held in a longitudinal direction by a second holding unit,
wherein the first holding unit comprises:
a pair of rising pieces integrally formed on the bottom plate of the bottom case, for pinching the rectangular frame from both sides thereof;
a pushing piece respectively provided with respect to the rising pieces, for pinching the rectangular frame between the pushing piece and the bottom plate; and
an attaching piece extending in a longitudinal direction, the attaching piece being slidably engaged with a groove-shaped portion formed by the pair of rising pieces the pushing piece, and the bottom plate with respect to the longitudinal direction,
wherein the second holding unit comprises a pair of engaging pieces respectively provided on the bottom plate and the top case or on the bottom plate and the front panel, for pinching the rectangular frame in the longitudinal direction, and
wherein an engaging piece of bottom plate side receives a rear end of the rectangular frame when the attaching pieces are engaged with the groove-shaped portion and the disk loader is slid backward being pushed so as to position the disk loader.

2. A structure of attaching a disk loader, comprising:
an outer housing being divided into a top case, a bottom case including a bottom plate, and a front panel, the outer housing comprising a first holding unit, a second holding unit; and
a substantially rectangular frame comprising a disk loading element including a disk tray, the rectangular frame capable of being configured to be fixed by a plurality of screws onto the bottom plate, wherein, instead of fixing the rectangular frame to the bottom plate of the bottom case by the plurality of screws, the frame is held in a lateral direction and a vertical direction by the first holding unit and is held in a longitudinal direction by a second holding unit, wherein the first holding unit has a function of allowing the rectangular frame to slide in the longitudinal direction.

3. A structure of attaching a disk loader according to claim 2, wherein the first holding unit comprises:
a pair of rising pieces integrally formed on the bottom plate of the bottom case, for pinching the rectangular frame from both sides thereof; and
a pushing piece pinching the rectangular frame between the pushing piece and the bottom plate.

4. A structure of attaching a disk loader according to claim 3, wherein the pushing piece is individually provided for the respective rising pieces.

5. A structure of attaching a disk loader according to claim 2, wherein the second holding unit comprises a pair of engaging pieces respectively provided on the bottom plate and the top case or on the bottom plate and the front panel, for pinching the rectangular frame in the longitudinal direction.

6. A structure of attaching a disk loader according to claim 4, wherein an attaching piece extending in a longitudinal direction is slidably engaged with a groove-shaped portion formed by the pair of rising pieces the pushing piece, and the bottom plate with respect to the longitudinal direction.

7. A method of attaching a disk loader, comprising:
preparing an outer housing being divided into a top case, a bottom case including a bottom plate, and a front panel, the outer housing comprising a first holding unit, a second holding unit; and
holding, in a lateral direction and a vertical direction, by the first holding unit a rectangular frame comprising a disk loading element including a disk tray, the rectangular frame capable of being configured to be fixed by a plurality of screws onto a bottom plate of the bottom case, instead of fixing the rectangular frame to a bottom plate of bottom case by plurality of screws; and
holding the frame in a longitudinal direction by a second holding unit,
wherein the first holding unit comprises:
a pair of rising pieces integrally formed on the bottom plate of the bottom case, for pinching the rectangular frame from both sides thereof;
a pushing piece respectively provided with respect to the rising pieces, for pinching the rectangular frame between the pushing piece and the bottom plate; and
an attaching piece extending in a longitudinal direction, the attaching piece being slidably engaged with a groove-shaped portion formed by the pair of rising pieces, the pushing piece, and the bottom plate with respect to the longitudinal direction,
wherein the second holding unit comprises a pair of engaging pieces respectively provided on the bottom plate and the top case or on the bottom plate and the front panel, for pinching the rectangular frame in the longitudinal direction, and
wherein an engaging piece of bottom plate side receives a rear end of the rectangular frame when the attaching pieces are engaged with the groove-shaped portion and the disk loader is slid backward being pushed so as to position the disk loader.
